(19) United States
(12) Patent Application Publication
(10) Pub. No.: US 2023/0069955 A1
(43) Pub. Date: Mar. 9, 2023

(54) PRINTED MATERIAL, PRINTING APPARATUS, PRINTING SYSTEM, AND PRINTING METHOD

(71) Applicants: Hiroki TAKAHASHI, Kanagawa (JP); Masayuki TSUCHIYA, Tokyo (JP)

(72) Inventors: Hiroki TAKAHASHI, Kanagawa (JP); Masayuki TSUCHIYA, Tokyo (JP)

(21) Appl. No.: 17/892,167

(22) Filed: Aug. 22, 2022

(30) Foreign Application Priority Data
Sep. 7, 2021 (JP) 2021-145538

(51) Int. Cl. B41F 16/00; B41J 11/00; B41F 19/00

(52) U.S. Cl. CPC B41F 16/0026; B41J 11/00214; B41F 19/004; B41F 19/007

(57) ABSTRACT

A printed material includes a base material, an image layer, and an adhesive layer. The image layer includes an image of a first shape. The adhesive layer has a second shape. The image layer and the adhesive layer are on opposite sides of the base material.

### CROSS-REFERENCE TO RELATED APPLICATION

This patent application is based on and claims priority pursuant to 35 U.S.C. § 119(a) to Japanese Patent Application No. 2021-145538, filed on Sep. 7, 2021, in the Japan Patent Office, the entire disclosure of which is hereby incorporated by reference herein.

### BACKGROUND

### Technical Field

Embodiments of the present disclosure relate to a printed material, a printing apparatus, a printing system, and a printing method.

### Related Art

As known in the art, a foil is formed on an adhesive layer formed on a recording medium, with a liquid from a printing apparatus that discharges an ultraviolet curable liquid. Another technique is known to impart a three-dimensional appearance to a foil by multi-layer printing using the thickness of the ultraviolet curable liquid.

Various techniques have been disclosed that a printed material in which a basic image with fine halftone dots is formed on a front surface of a light-permeable base material in order to create a valuable printed material for preventing forgery. A light-reflecting base material is provided on the back of the region of the light-permeable base material on which the basic image is printed.

However, since a foil such as the light-reflecting base material is formed on the entire surface of the base material of a typical printed material for preventing forgery, a printed material does not have a three-dimensional appearance and a degree of freedom in design in which an image layer such as a basic image and the foil can be formed respectively in a different shape.

### SUMMARY

Embodiments of the present disclosure described herein provide a novel printed material including a base material, an image layer, and an adhesive layer. The image layer includes an image of a first shape. The adhesive layer has a second shape. The image layer and the adhesive layer are on opposite sides of the base material.

Embodiments of the present disclosure described herein provide a novel printing apparatus including a first liquid discharger and a second liquid discharger. The first liquid discharger forms an image layer with a first liquid on a first surface of the base material. The image layer includes an image of a first shape. The second liquid discharger forms an adhesive layer of a second shape with a second liquid on a second surface of the base material opposite to the first surface on which the image layer is formed.

Embodiments of the present disclosure described herein provide a novel printing method including forming. The forming forms an image layer with a first liquid on a first surface of a base material. The image layer includes an image of a first shape. The forming forms an adhesive layer of a second shape with a second liquid on a second surface of the base material opposite to the first surface on which the image layer is formed.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a cross-sectional view of a configuration of a printed material according to an embodiment of the present disclosure;

FIG. 2 is a plan view of a configuration of the printed material according to an embodiment of the present disclosure;

FIG. 3 is a diagram illustrating a layer configuration of the printed material according to an embodiment of the present disclosure;

FIG. 4 is a cross-sectional view of an example of a configuration of a foil formed on the printed material according to an embodiment of the present disclosure;

FIG. 5 is a cross-sectional view of a configuration of the printed material according to a control sample;

FIG. 6 is a schematic block diagram illustrating a printing system according to an embodiment of the present disclosure;

FIG. 7 is a diagram illustrating a configuration of a printing apparatus according to an embodiment of the present disclosure;

FIG. 8 is a diagram illustrating a configuration of a foil transfer apparatus according to an embodiment of the present disclosure;

FIG. 9 is a flowchart of a. printing operation by the printing system according to an embodiment of the present disclosure;

FIG. 10 is a diagram illustrating the printing operation by the printing system according to an embodiment of the present disclosure;

FIG. 11 is a diagram illustrating a gloss finish of the foil according to an embodiment of the present disclosure;

FIG. 12 is a diagram illustrating a matte finish of the foil according to an embodiment of the present disclosure;

FIG. 13 is a diagram illustrating a first example of the method for controlling the shape of the adhesive layer according to an embodiment of the present disclosure;

FIG. 14 is a diagram illustrating a second example of the method for controlling the shape of the adhesive layer according to an embodiment of the present disclosure;

FIG. 15 is a flowchart of a foil transfer operation by the printing system according to an embodiment of the present disclosure; and

FIGS. 16A and 16B are diagrams illustrating the foil transfer operation by the printing system according to an embodiment of the present disclosure.

The accompanying drawings are intended to depict embodiments of the present invention and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed fix the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below As used herein, the singular forms “a,” “an,” and “the” are intended to include the plural forms as well, unless the context clearly indicates otherwise.

Embodiments of the present disclosure are described below with reference to the drawings, In the drawings, like reference signs denote like elements, and overlapping description may be omitted where appropriate.

Further, the embodiments described below are some examples of a printed material, a printing apparatus, a printing system, and a printing method for embodying the technical idea. of the disclosure, and embodiments of the disclosure are not limited to the embodiments described below For example, the dimension, material, and shape of components and the relative positions of the arranged components are given by way of example in the following description, and the scope of the present disclosure is not limited thereto unless particularly specified. The size, positional relation, and the like of components illustrated in the drawings may be exaggerated for clarity of description.

### Embodiments

Configuration Example of Printed Material 1

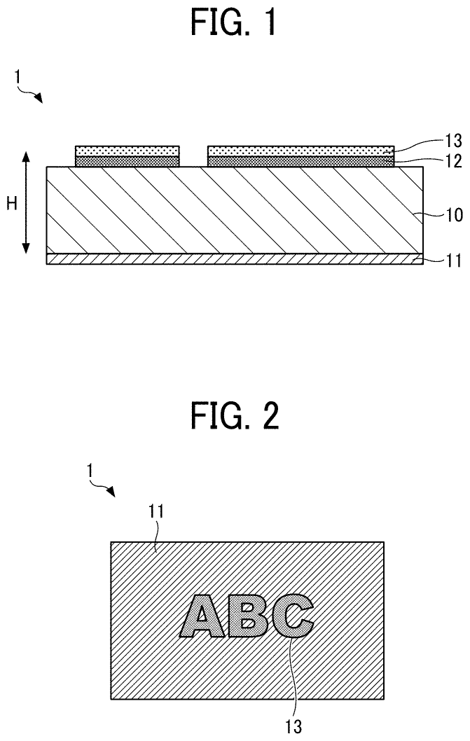

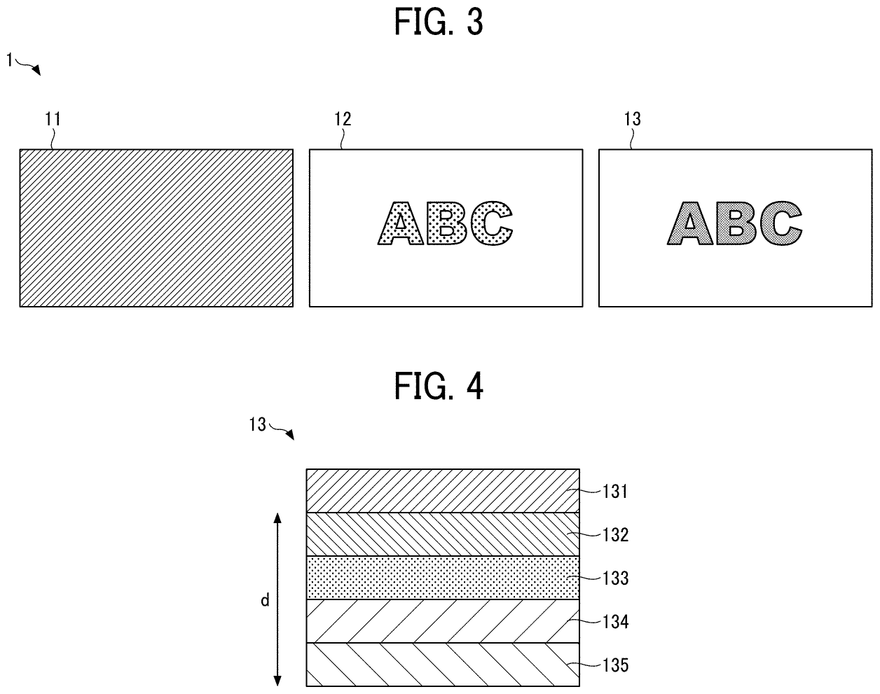

The configuration of a printed material 1 according to the embodiments of the present disclosure is described below with reference to FIGS. 1 to 4. FIG. 1 and FIG. 2 are diagrams illustrating a configuration of the printed material 1. FIG. 1 is a cross-sectional view of the printed material 1. FIG. 2 is a plan view of the printed material 1. FIG. 3 is a diagram illustrating a layer configuration of the printed material 1. FIG. 4 is a cross-sectional view of a configuration of a foil formed on the printed material 1.

As illustrated in FIG. 1, the printed material 1 includes a base material 10, an image layer 11 including an image having a first shape, and an adhesive layer 12 on which a foil is formed and having a second shape. The image layer 11 and the adhesive layer 12 are formed on opposite sides of the base material 10, In the present embodiment, the printed material 1 further includes a foil 13 formed on the adhesive layer 12 and having the second shape.

The base material 10 is a plate-like or sheet-like member including a resin material or glass and having translucency to visible light. The resin material may be acrylic, polyvinyl chloride, or polycarbonate. Note that the visible light has wavelengths from approximately 380 nanometers (nm) to approximately 780 nm.

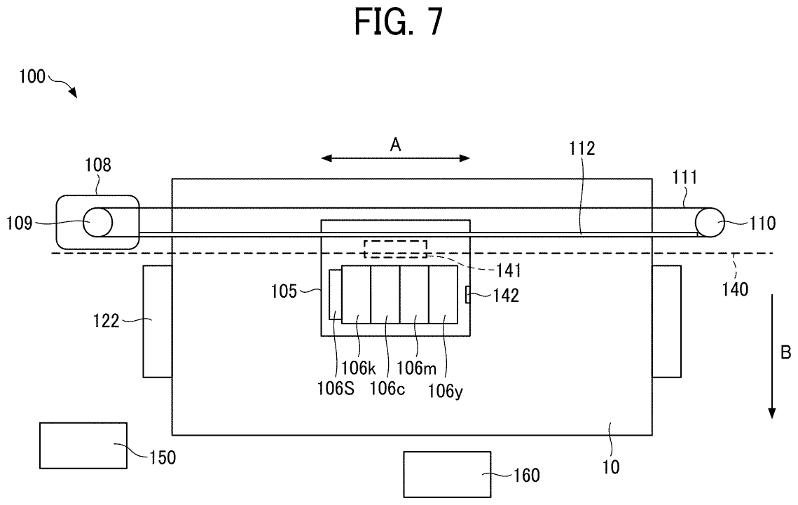

The image of the first shape of the image layer 11 is any image including an image of characters, scenery, or an animal. The image layer 11 is formed by printing on one surface of the base material 10. In the present embodiment, the image layer 11 is formed with ink discharged from a printing apparatus 100. Note that the details of the printing apparatus 100 is separately described below, with reference to FIG. 7,

The adhesive layer 12 serves as an adhesive for transferring the foil. The adhesive layer 12 is formed on the surface of the base material 10 opposite to the surface on which the image layer 11 is formed. In the present embodiment, the adhesive layer 12 is formed with ultraviolet curable ink discharged from the printing apparatus 100.

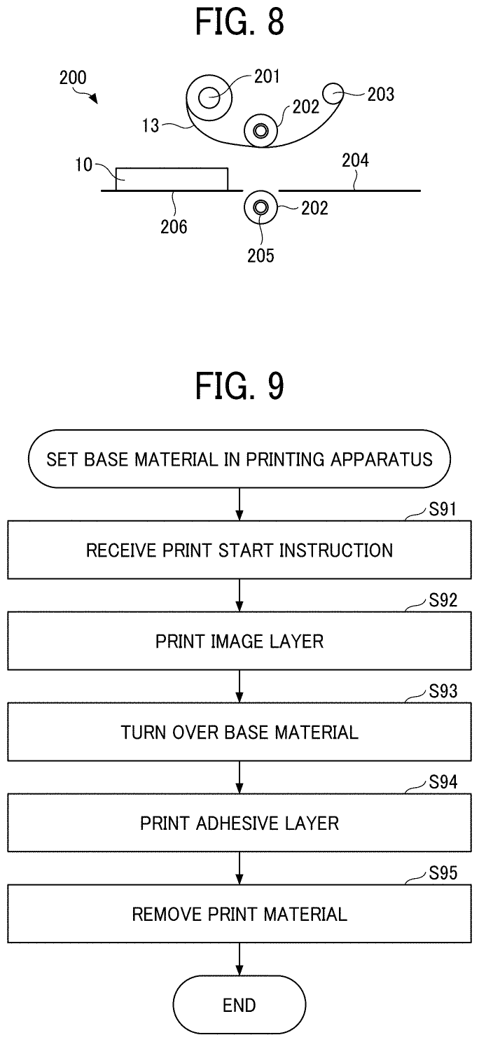

The foil 13 is formed on the adhesive layer 12 by a foil transfer apparatus 200 in order to increase the gloss of the printed material 1. Note that the details of the foil transfer apparatus 200 is separately described below, with reference to FIG. 8.

The distance H illustrated in FIG. 1 is the distance between the image layer 11 and the foil 13 formed on the adhesive layer 12. The printed material 1 achieves a three-dimensional appearance obtained by selecting the distance H appropriately The shape of the image layer 11 and the shape of the foil on the adhesive layer 12 are different from each other by differentiating the first shape and the second shape, so that the printed material 1 has a higher degree of freedom in design. Further, the non-glossy base material 10 contributes to an increase in the contrast with the gloss of the foil 13, so that the gloss of the foil 13 is more emphasized. The first shape and the second shape may be formed in any shape based on image data.

As illustrated in FIG. 2, the printed material 1 has, for example, characters “ABC” formed by the foil 13 with an image layer 11 having a predetermined pattern such as a stripe pattern as a background. FIG. 3 illustrates the image layer 11 having a predetermined pattern, the adhesive layer 12 formed on a surface of the base material 10 opposite to the image layer 11, and the foil 13 formed on the adhesive layer 12 in the printed material 1. Each image of the image layer 11 and the adhesive layer 12 has any shape corresponding to image data.

As illustrated in FIG. 4, the foil 13 includes three layers, i.e., a coloring layer 133, a deposition layer 134, and a foil adhesive layer 135. The foil 13 is laminated and held on a base film 131 via a release layer 132 before being transferred to the base material 10.

The base film 131 functions as a base material for holding the release layer 132, the coloring layer 133, the deposition layer 134, and the foil adhesive layer 135.

The release layer 132 is used to easily peel from the base film 131 when the coloring layer 133, the deposition layer 134, and the foil adhesive layer 135 are transferred onto the printed material 1.

The coloring layer 133 is used for coloring the foil 13. In a case where the color of the foil 13 is gold, the coloring layer 133 appears to be a. yellow layer.

The deposition layer 134 is a metal layer for the gloss.

The foil adhesive layer 135 is to be transferred to the printed material 1 serving as a transfer object.

In the present embodiment, the configuration of the foil 13 before being transferred onto the base material 10 is a roll shape having a paper core around which the base film 131 holding the foil 13 is wound. However, the foil 13 is not limited to this configuration. The foil 13 may have, for example, a sheet-like shape.

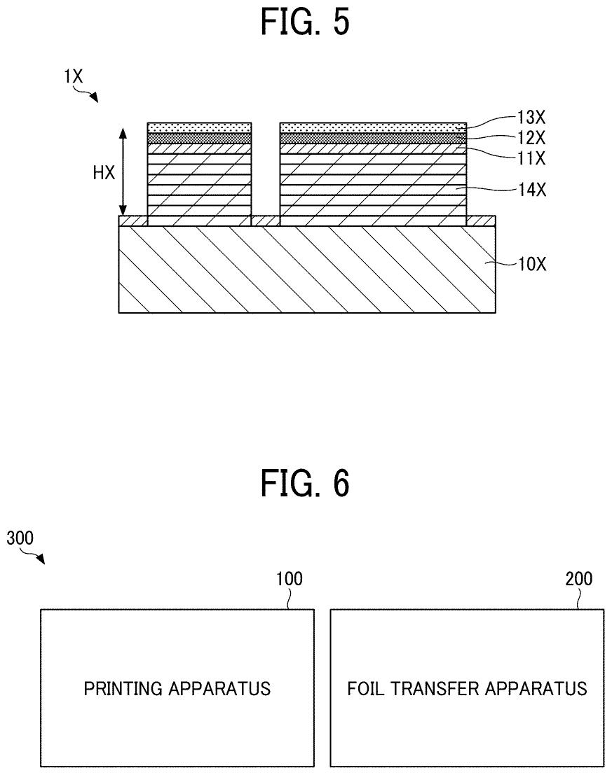

FIG. 5 is a cross-sectional view of a configuration of a printed material 1X according to a control sample. As illustrated in FIG. 5, the printed material 1X includes a base material 10X, a laminated ink layer 14X, an image layer 11X, an adhesive layer 12X, and a foil 13X.

The printed material 1X has a three-dimensional appearance obtained according to a distance HX between the image layer 11X and the foil 13X. However, the greater number of ink layers in the laminated ink layer 14X to obtain the three-dimensional appearance results in the longer printing time.

Further, when an ink jet printer is used for laminating an ink layer, the ink jet printer sets a distance between an ink jet head and a base material to a predetermined distance, for to example, 2 millimeters (mm) or less. For this reason, the lamination height of the ink layer is set to, for example, about several hundred micrometers, and the distance HX between the image layer 11 and the foil 13 is limited.

Furthermore, since the image layer 11X and the adhesive layer 12X of the printed material 1X are provided on the same surface of the base material 10X, the foil 13X is to be transferred not only onto the adhesive layer 12X but also onto the image layer 11X depending on the characteristics of the ink. When the foil 13X is transferred onto both the adhesive layer 12X and the image layer 11X, positional deviation of the foil 13X is likely to occur, and the yield ratio of the printed material 1X may decrease.

On the other hand, since the printed material 1 according to the present embodiment has the distance H between the foil 13 and the image layer 11 due to the thickness of the base material 10 as illustrated in FIG. 1, the printed material 1 does not include a plurality of ink layers to be laminated. For this reason, the printing time to form the printed material 1 is reduced, so that the high value-added printed material 1 having the gloss is formed with high productivity. in addition, since the image layer 11 and the adhesive layer 12 are formed in the printed material 1 with being separated from the base material 10, the positional deviation of the foil 13 is reduced and the yield ratio is enhanced.

Configuration Example of Printing System 300

FIG. 6 is a schematic block diagram illustrating a printing system 300 according to an embodiment of the present disclosure. The printing system 300 includes a printing apparatus 100 and a foil transfer apparatus 200.

The printing apparatus 100 forms the image layer 11 on the base material 10 by discharging ultraviolet curable coloring ink and printing any image of the first shape on the base material 10. Moreover, the printing apparatus 100 forms the adhesive layer 12 on the base material 10 by discharging ultraviolet curable clear ink or primer ink and printing any image having the second shape on the base material 10.

The foil transfer apparatus 200 is configured to transfer the foil 13 having the second shape onto the adhesive layer 12.

The coloring ink is an example of a first liquid. The clear ink or the primer ink is an example of a second liquid corresponding to an ultraviolet-curable liquid.

In the present embodiment, the printing apparatus 100 discharges the ultraviolet curable clear ink to form the adhesive layer 12.

The printing system 300 according to the present embodiment discharges both the first liquid and the second liquid. However, the printing system 300 is not limited to discharge both the first liquid and the second liquid. The printing system 300 may include two or more printing apparatuses, such as a first printing apparatus that discharges the first liquid and a second printing apparatus that discharges the second liquid. Further, the first liquid may not be an ultraviolet curable liquid.

Configuration Example of Printing Apparatus 100

FIG. 7 is a diagram illustrating an example of a configuration of the printing apparatus 100.

As illustrated in FIG. 7, the printing apparatus 100 includes a carriage 105, an ink discharging head 106, a platen 122, an encoder sensor 141, and an ultraviolet irradiation light source 142. The printing apparatus 100 further includes a main scanning motor 108, a gear 109, a pressure roller 110, a timing belt 111, a guide rod 112, an encoder sheet 140 (linear scale), a controller 150, and an operation unit 160. The printing apparatus 100 forms the image layer 11 and the adhesive layer 12 on the base material 10 conveyed by, for example, a registration roller along a direction indicated by an arrow B (sub-scanning direction).

The carriage 105 includes an ink discharging head I 06Y that discharges yellow (Y) coloring ink, an ink discharging head 106M that discharges magenta (M) coloring ink, an ink discharging head 106C that discharges cyan (C) coloring ink, and an ink discharging head 106K that discharges black (K) coloring ink. Further, the carriage 105 includes an ink discharging head 106S that discharges clear ink to form the adhesive layer 12. These ink discharging heads 1061 106M, 106C, and 106K have the substantially same configuration except that the types of inks to be discharged are different. For this reason, these ink discharging heads 106Y 106M, 106C, and 106K are collectively referred to as an ink discharging head 106 unless particularly distinguished from each other.

Each of the ink discharging heads 106Y, 106M, 106C, and 106K is an example of a first liquid discharger that forms the image layer 11 including the image of the first shape on the base material 10 with the first liquid. The ink discharging head 106S is an example of a second liquid discharger that forms the adhesive layer 12 of the second shape on the surface of the base material 10 opposite to the surface on which e image layer 11 is formed, using the second liquid.

The printing apparatus 100 transmits driving force of the main scanning motor 108 to the carriage 105 by the gear 109, the pressure roller 110, and the timing belt 111, so that the carriage 105 is caused to reciprocally move along the guide rod 112 in a direction indicated by the arrow A (main-scanning direction). The encoder sensor 141 attached to the carriage 105 reads the encoder sheet 140 provided along the movement direction of the carriage 105, so that the printing apparatus 100 detects the position of the carriage 105.

The printing apparatus 100 forms the image layer 11 and the adhesive layer 12 on the base material 10 by alternately performing movement of the carriage 105 in the direction indicated by the arrow A and conveyance of the base material 10 in the direction indicated by the arrow B.

The ultraviolet irradiation light source 142 is an example of an irradiator that irradiates the adhesive layer 12 formed on the base material 10 with ultraviolet light. The ultraviolet light is an example of light irradiated on the adhesive layer 12. The ultraviolet irradiation light source 142 irradiates ultraviolet light to cure the ink discharged from the ink discharging head 106. In the present embodiment, the ultraviolet irradiation light source 142 also cures the coloring ink included in the image layer 11 by irradiating the image layer 11 formed on the base material 10 with ultraviolet light in addition to the adhesive layer 12.

The controller 150 causes each of the plurality of ink discharging heads 106 to discharge ink, the ultraviolet irradiation light source 142 to irradiate ultraviolet light, the carriage 105 to move, and the registration roller to convey the base material 10. Further, the controller 150 receives image data via a network connected to the printing apparatus 100 and performs a reverse process on image data to form the image layer 11 among the received image data.

The controller 150 is configured to control a time interval between the time when the adhesive layer 12 is formed on the base material 10 by the second liquid and the time when the adhesive layer 12 is irradiated with ultraviolet light by the ultraviolet irradiation light source 142, based on information of the designated gloss. In addition, the controller 150 controls the ultraviolet irradiation light source 142 to cause the ultraviolet irradiation light source 142 to irradiate ultraviolet light to the adhesive layer 12 shorter in the irradiation time of ultraviolet light, than to the image layer 11 or to give the irradiation intensity when ultraviolet light is irradiated to the adhesive layer 12 lower than the irradiation intensity when ultraviolet light is irradiated to the image layer 11.

The operation unit 160 of the printing system 300 is used to instruct printing to the printing apparatus 100, and to designate whether the gloss of the foil 13 to be formed on the printed material 1 is to be a matte finish or a gloss finish. The operation unit 160 includes a touch screen that receives touch operations.

Configuration Example of Foil Transfer Apparatus 200

FIG. 8 is a diagram illustrating an example of a configuration of the foil transfer apparatus 200. The foil transfer apparatus 200 includes a sheet feeding unit 201, a transfer roller pair 202, a reeler 203, a transfer roller 204, a heater 205, and a placement table 206.

The foil transfer apparatus 200 transfers the foil 13 to the base material 10 while conveying the base material 10, which is a transfer object, on the placement table 206 by rotating each of the sheet feeding unit 201, the transfer roller pair 202, and the reeler 203 by a driving force of, for example, a motor.

The sheet feeding unit 201 is a supply mechanism that supplies the base film 131 holding the foil 13 to the base material 10 by rotating a roller while winding the base film 131 holding the foil 13 around the roller.

The transfer roller pair 202 includes two transfer rollers to transfer the foil 13 to the base material 10. The heater 205 is disposed inside one of the two transfer rollers included in the transfer roller pair 202. At least the surface of the transfer roller is made of an elastic material such as rubber or sponge. The transfer roller pair 202 nips the base material 10 and the base film 131 and between two transfer rollers and applies pressure to transfer the foil 13 held by the base film 131 onto the base material 10.

The reeler 203 is a reeling mechanism that reels the base film 131 after transferring the foil 13 to the base material 10.

Operation Example of Printing System 300

Printing Operation Example

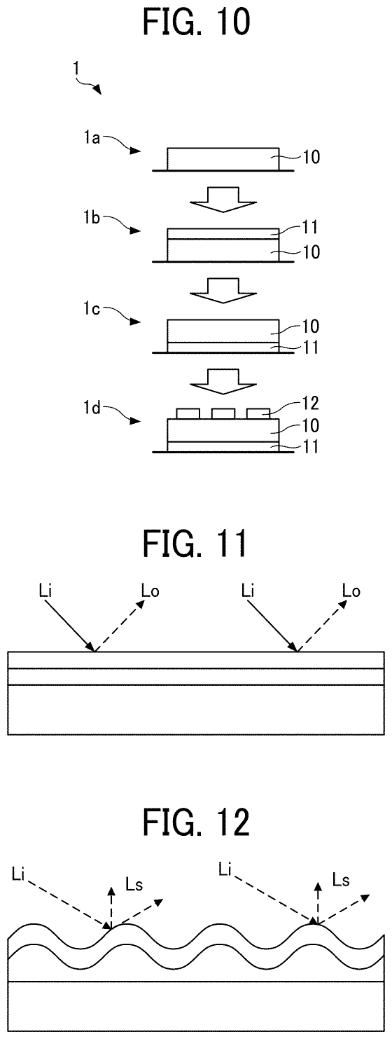

Descriptions are given of a printing operation performed by the printing system 300 with reference to FIGS. 9 and 10. FIG. 9 is a flowchart of the printing operation of the printing system 300. FIG. 10 a diagram illustrating an example of the printing operation of the printing system 300. FIG. 10 illustrated states 1a to 1d of the printed material 1 corresponding to the operation steps of the flowchart in FIG. 9.

The printing system 300 starts an operation after the base material 10 is set in the printing apparatus 100. The base material 10 may be set to the printing apparatus 100 manually. Alternatively, the printing system 300 may set the base material 10 to the printing apparatus 100 using a handling mechanism of the base material 10. When the operation in the flowchart of FIG. 9 is started, the printed material 1 is in the state la as illustrated in FIG. 10. The printed material 1 in the state 1a includes the base material 10 alone before the start of printing.

First, the printing system 300 receives a print start instruction from the printing apparatus 100 (step S91). The printing apparatus 100 receives the print start instruction by receiving image data from an external personal computer (PC) by the controller 150 or by receiving an operation input of the print start instruction from a user via the operation unit 160.

Subsequently, the printing system 300 causes the printing apparatus 100 to print the image layer 11 on the surface of the base material 10 facing the ink discharging head 106 (step S92). The ink discharging head 106 of the printing apparatus 100 discharges the coloring ink onto the base material 10. Then, the ultraviolet irradiation light source 142 of the printing apparatus 100 irradiates ultraviolet light to the coloring ink applied to the base material 10. As a result, the image layer 11 is fixed (cured) to the base material 10. By executing step S92, the state of the printed material 1 is changed to the state 1b in which the image layer 11 is formed on one face of the base material 10 as illustrated in FIG. 10.

Subsequently, the printing system 300 turns over the base material 10 to replace the face of the base material 10 that is to face the ink discharging head 106 (step S93). In the present embodiment, the printing system 300 may perform an operation of turning over the base material 10 by the handling mechanism for the base material 10. Alternatively, a user may perform an operation of turning over the base material 10. As a result of step S93, the state of the printed material 1 is changed to the state 1c in which the position of the image layer 11 on the base material 10 is reversed with respect to the state 1b, as illustrated in FIG. 10.

Subsequently, the printing system 300 causes the printing apparatus 100 to print the adhesive layer 12 on the face of the base material 10 opposite to the face on which the image layer 11 is formed (step S94). The ink discharging head 106 of the printing apparatus 100 discharges the clear ink onto the base material 10. Then, the ultraviolet irradiation light source 142 of the printing apparatus 100 irradiates ultraviolet light to the clear ink applied to the base material 10. As a result, the adhesive layer 12 of the clear ink is fixed (cured) on the base material 10. As a result of step S94, the state of the printed material 1 is changed to the state 1d in which the adhesive layer 12 is formed on the face of the base material 10 opposite to the face on which the image layer 11 is formed, as illustrated in FIG. 10.

The irradiation time by the ultraviolet irradiation light source 142 when the ultraviolet light is irradiated in forming the adhesive layer 12 is preferably shorter than the irradiation time when the ultraviolet light is irradiated in forming the image layer 11. Alternatively, the irradiation intensity of the ultraviolet light when the ultraviolet light is irradiated in forming the adhesive layer 12 is preferably lower than the irradiation intensity when the ultraviolet light is irradiated on the image layer 11. The controller 150 controls the irradiation intensity and irradiation time of the ultraviolet irradiation light source 142. Due to the above-described configuration, the coloring ink is reliably cured on the image layer 11 and the image layer 11 is reliably fixed to the base material 10, and the transfer efficiency of the foil 13 is increased by transferring the foil 13 in a state in which the clear ink is uncured, in other words, in a state in which the clear ink is not completely cured.

Subsequently, the printing system 300 ejects the printed material 1 in which the image layer 11 and the adhesive layer 12 are formed on the base material 10 (step S95). In the present embodiment, the printing system 300 performs an operation of ejecting the printed material 1 by the handling mechanism of the base material 10. However, a user may perform this operation.

In this way, the printing system 300 forms the image layer 11 and the adhesive layer 12 on the base material 10.

The order of step S92 and step S94 may be reversed. However, if the adhesive layer 12 is printed before the image layer 11, curing of the clear ink of the adhesive layer 12 is accelerated by ultraviolet light irradiated while the image layer 11 is printed. As a result, it is likely that the adhesive force to adhere the foil 13 is reduced. For this reason, the image layer 11 is preferably printed before the adhesive layer 12.

In the present embodiment, the ink discharging heads 106Y, 106M, 106C, and 106K discharge the coloring ink from the same side as viewed from the base material 10. After the image layer 11 is printed on the base material 10 with the coloring ink, the base material 10 is turned over and the adhesive layer 12 is printed. Since the image layer 11 is formed on the opposite side of the adhesive layer 12 on the base material 10, the controller 150 of the printing system 300 controls the image data of the image layer 11 to be reversed before printing the image data of the image layer 11 on the base material 10.

Example of Gloss Control Method

In the present embodiment, when the foil transfer apparatus 200 transfers the foil 13, the surface shape of the foil 13 matches the surface shape of the adhesive layer 12. For this reason, the gloss of the foil 13 may be controlled by controlling the surface shape (for example, unevenness or flatness) of the adhesive layer 12.

FIG. 11 a diagram illustrating an example of the gloss finish of the foil 13 by the printing system 300. FIG. 12 is a diagram illustrating an example of the matte finish of the foil 13 by the printing system 300.

As illustrated in FIG. 11, when the surface of the adhesive layer 12 is flat, the amount of specular reflection light Lo of incident light Li by the adhesive layer 12 increases, so that the foil 13 appears glossy.

As illustrated in FIG. 12, if the surface of the adhesive layer 12 is uneven, the amount of the diffuse reflection light Ls of the incident light Li on the adhesive layer 12 increases, so that the foil 13 has matte gloss.

FIG. 13 is a diagram illustrating a first example of the method for controlling the shape of the adhesive layer 12 by the printing system 300, to obtain the gloss.

As illustrated in FIG. 13, in order to flatten the surface of the foil 13 to obtain the gloss, a time is provided for the clear ink, the clear ink is applied to the base material 10 for a given period of time to wet and spread, and then the clear ink is cured. By so doing, the surface of the foil 13 is flattened by wetting and spreading the clear ink, so that the printed material 1 has a gloss finish.

Descriptions are given of an operation to form the adhesive layer 12 to obtain the gloss.

First, the printing system 300 discharges the clear ink to apply the clear ink onto the base material 10 (state 12a in FIG. 13).

Subsequently, the printing system 300 causes the base material 10 to wait for a predetermined time. More specifically, the printing system 300 turns off the ultraviolet irradiation light source 142 and move the carriage 105. After the ink discharging head 106S discharges the clear ink onto the base material 10, the printing system 300 stops the operation for a predetermined time. As the predetermined time elapses, the clear ink is wet and spread over the base material 10, and the clear ink is flattened (state 12b in FIG. 13).

Then, the clear ink is cured by irradiation with ultraviolet light. More specifically. after the predetermined time has elapsed, the printing system 300 turns on the ultraviolet irradiation light source 142, moves the carriage 105, and irradiates the clear ink that is wet and spread over the base material 10 with ultraviolet light to cure the clear ink (state 12c in FIG. 13).

Due to the above-described configuration, the printing system 300 controls the shape of the adhesive layer 12 to be glossy.

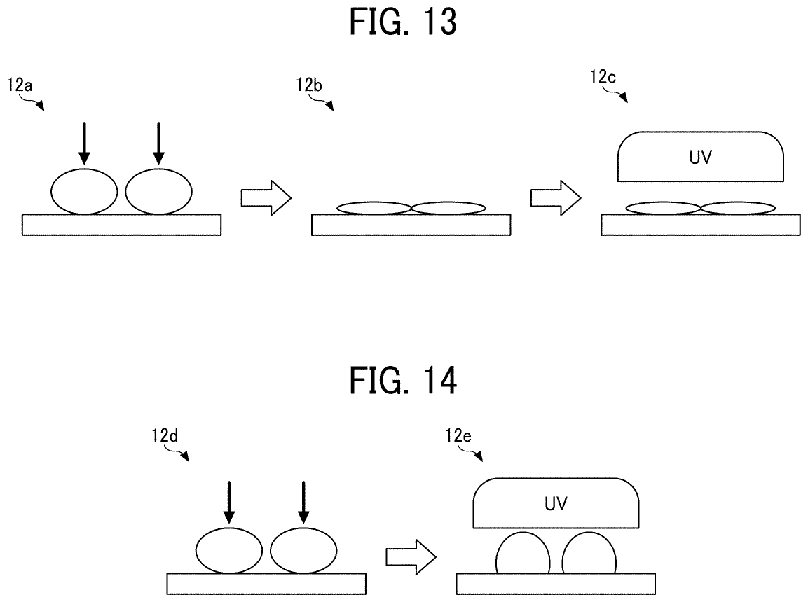

FIG. 14 a diagram illustrating a second example of the method for controlling the shape of the adhesive layer 12 by the printing system 300, to obtain the matte gloss.

As illustrated in FIG. 14, to obtain the matte gloss with the uneven surface of the foil 13, the clear ink is cured immediately after the clear ink is applied to the base material 10. As a result, unevenness remains on the surface of the clear ink, and the printed material 1 is finished with the reduced amount of the gloss.

Descriptions are given of an operation to form the adhesive layer 12 to obtain the matte gloss.

First, the printing system 300 discharges the clear ink to apply the clear ink onto the base material 10 (state 12d in FIG, 14).

Immediately after the clear ink is applied, the clear ink is cured by irradiation with ultraviolet light. More specifically, while the ultraviolet irradiation light source 142 is turned on, the carriage 105 is moved and the ink discharge head 1065 discharges the clear ink onto the base material 10. After the carriage 105 has been moved, the ultraviolet irradiation light source 142 immediately irradiates with ultraviolet light, so that the ink is cured (state 12e in FIG. 14).

The controller 150 controls a time interval from when the ink discharging head 1065 discharges the clear ink to form the adhesive layer 12 on the base material 10 to when the ultraviolet irradiation light sources 142 irradiates the ultraviolet light, based on the information of the designated gloss. By so doing, the shape of the adhesive layer 12 is controlled, and the gloss of the foil 13 transferred to the adhesive layer 12 is controlled.

The information of the gloss may be information designating the gloss or the matte gloss included in the image data. Alternatively, the information of the gloss may be information indicating whether the foil 13 of the printed material I is to be printed in the matte finish or the gloss finish designated by a user using the operation unit 160.

Example of Foil Transfer Operation

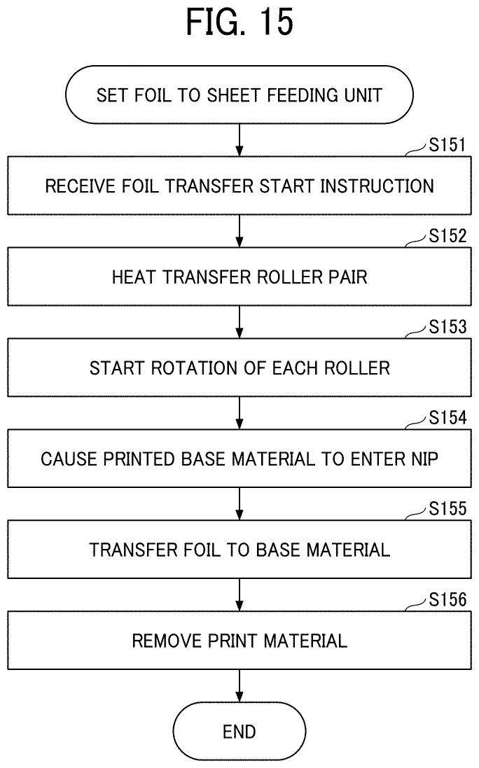

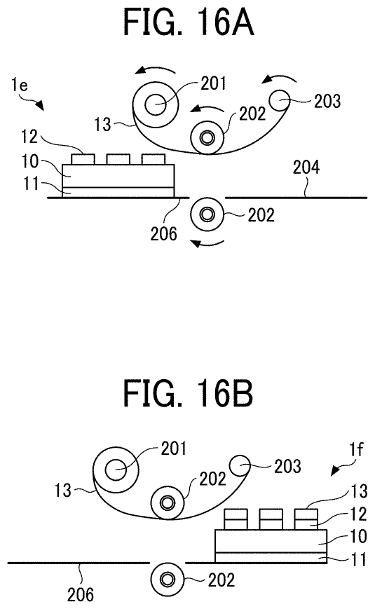

Descriptions are given of a foil transfer operation performed by the printing system 300 with reference to FIG. 15, FIGS. 16A and 16B. FIG. 15 is a flowchart of an example of the foil transfer operation by the printing system 300. FIGS. 16A and 16B are diagrams illustrating an example of the foil transfer operation by the printing system 300. FIG. 16A illustrates a state 1e before the foil transfer of the printed material 1 and FIG. 16B illustrates a state if after the foil transfer of the printed material 1.

Prior to the foil transfer operation by the printing system 300, a user attaches the base film 131 holding the foil 13 to the sheet feeding unit 201 and fixes the leading end of the base film 131 to the reeler 203 with an adhesive member such as an adhesion tape.

The printing system 300 starts an operation after the base film 131 holding the foil 13 is set in the foil transfer apparatus 200. A user may set the base material 10 to the foil transfer apparatus 200. Alternatively, the printing system 300 may set the base material 10 to the foil transfer apparatus 200 using a handling mechanism of the base material 10. When the printing system 300 starts the operation, the printed material 1 is in the state 1e before the base film 131 is transferred, as illustrated in FIG. 16A.

First, the priming system 300 receives a foil transfer start instruction from the foil transfer apparatus 200 (step S151). The foil transfer apparatus 200 receives the foil transfer start instruction by receiving image data from an external PC by the controller 150 or by receiving an operation input of the foil transfer start instruction from a user via the operation unit 160.

Subsequently, the printing system 300 heats the transfer roller pair 202 by the foil transfer apparatus 200 (step S152).

Subsequently, the printing system 300 starts rotation of each of the roller of the sheet feeding unit 201, the transfer roller pair 202, and the reeler 203 by the foil transfer apparatus 200 (step S153).

Subsequently, the priming system 300 conveys the base material 10 having the image layer 11 and the adhesive layer 12 to the nip formed by the transfer roller pair 202 (step S154). This operation may be performed manually by a user or automatically by providing a conveyance mechanism that conveys the base material 10 from the printing apparatus 100 to the foil transfer apparatus 200.

Subsequently, the printing system 300 transfers the foil 13 to the base material 10 by the foil transfer apparatus 200 (step S155). The transfer roller pair 202 applies heat and pressure to the base material 10 to transfer the foil 13 to the adhesive layer 12. As illustrated in FIG. 16B, the printed material I is in the state if in which the base film 131 is transferred.

Subsequently, the printing system 300 removes the printed material 1 in which the image layer 11 and the adhesive layer 12 are formed on the base material 10 (step S156), The printing system 300 performs an operation of removing the printed material 1 by the handling mechanism of the base material 10. However, a user may perform this operation manually.

Due to the above-described configuration, the printing system 300 further forms the foil 13 on the base material 10 on which the image layer 11 and the adhesive layer 12 are formed.

Effects of Printed Material 1

As described above, in the present embodiment, the printed material 1 includes the base material 10, the image layer 11, and the adhesive layer 12. The image layer 11 includes the image having the first shape. The adhesive layer 12 has the second shape on which the foil 13 is formed on the adhesive layer 12. The image layer 11 and the adhesive layer 12 are formed on opposite sides of the base material 10.

In the printed material 1, a three-dimensional appearance may be obtained by selecting the distance 14 appropriately. Since the shape of the image layer 11 and the shape of the foil on the adhesive layer 12 are different from each other by differentiating the first shape and the second shape, the printed material 1 having a high degree of freedom in design may be provided. Due to such a configuration, in the present embodiment, a printed material having a three-dimensional appearance and a high degree of freedom in design may be provided.

### Other Embodiments

Although the preferred embodiments of the invention have been described in detail above, the present disclosure is not limited to such specific embodiments, and various modifications and changes can be made within the scope of the gist of the embodiment of the invention described in the claims.

For example, the controller 150 provided in the printing apparatus 100 performs the reverse process. Alternatively, an external device outside the printing apparatus 100 may perform the reverse process.

Instead of the printing apparatus 100, a printing apparatus having a configuration in which the ink discharging heads 106Y, 106M, 106C, and 106K and the ink discharging head 106S are disposed on opposite sides of the base material 10 may perform printing on each surface of the base material 10. In this case, the step of turning over the base material 10 may be omitted, and the printing time may be shortened.

The printing apparatus 100 and the foil transfer apparatus 200 may be configured as an integrated apparatus instead of separate apparatuses.

The above-described embodiments also include a printing method. For example, the printing method includes a first step and a second step. The first step is to form an image layer including an image having a first shape on a base material with a first liquid. The second step is to form an adhesive layer having a second shape on a surface of the base material opposite to a surface on which the image layer is formed with a second liquid. The adhesive layer is used to form a foil having the second shape on the adhesive layer. Such an image forming method may provide effects equivalent to the effects of the above-described printing apparatus or the printing system. Such an image forming method may be implemented by a circuit such as a central processing unit (CPU) or a large-scale integration (LSI), an integrated circuit (IC) card, a single module, or the like.

The numbers such as ordinal numbers and numerical values that indicate quantity are all given by way of example to describe the technologies to implement the embodiments of the present disclosure, and no limitation is indicated to the numbers given in the above description. In addition, the description as to how the elements are related to each other, coupled to each other, or connected to each other are given by way of example to describe the technologies to implement the embodiments of the present disclosure, and how the elements are related to each other, coupled to each other, or connected to each other to implement the functionality in the present disclosure is not limited thereby.

Further, the division of blocks in the functional block diagrams is given by way of example. A plurality of blocks may be implemented as one block, or one block may be divided into a plurality of blocks. Alternatively, some functions may be moved to other blocks. Further, the functions of a plurality of blocks that have similar functions may be processed in parallel or in a time-division manner by a single unit of hardware or software.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

What is claimed is:

1. A printed material comprising:
a base material;
an image layer including an image of a first shape; and
an adhesive layer of a second shape,
the image layer and the adhesive layer being on opposite sides of the base material.

2. The printed material according to claim 1, further comprising a foil on the adhesive layer, the foil having the second shape.

3. A printing apparatus comprising:
a first liquid discharger configured to form an image layer with a first liquid on a first surface of the base material, the image layer including an image of a first shape; and
a second liquid discharger configured to form an adhesive layer of a second shape with a second liquid on a second surface of the base material opposite to the first surface on which the image layer is formed.

4. The printing apparatus according to claim 3, further comprising:
an irradiator configured to irradiate the adhesive layer on the base material with ultraviolet light; and
control circuitry configured to control a time interval between a time when the adhesive layer is formed with the second liquid on the base material and a time when the adhesive layer is irradiated with the ultraviolet light by the irradiator, based on information of a designated gloss, the second liquid being an ultraviolet-curable liquid.

5. The printing apparatus according to claim 3, further comprising:
an irradiator configured to irradiate the image layer and the adhesive layer on the base material with ultraviolet light; and
control circuitry configured to control the irradiator to irradiate the adhesive layer with the ultraviolet light in an irradiation time shorter than or at an irradiation intensity lower than to irradiate the image layer with the ultraviolet light, each of the first liquid and the second liquid being an ultraviolet-curable liquid.

6. A printing system comprising:
the printing apparatus according to claim 3; and
a foil transfer apparatus configured to transfer the foil having the second shape onto the adhesive layer.

7. A printing method comprising:
forming an image layer with a first liquid on a first surface of a base material, the image layer including an image of a first shape; and
forming an adhesive layer of a second shape with a second liquid on a second surface of the base material opposite to the first surface on which the image layer is formed.

8. The printing method according to claim 7, further comprising transferring a foil of the second shape onto the adhesive layer.

9. The printing method according to claim 7, further comprising:
irradiating the adhesive layer on the base material with ultraviolet light by an irradiator; and
controlling a time interval between a time when the adhesive layer is formed with the second liquid on the base material and a time when the adhesive layer is irradiated with the ultraviolet light by the irradiator, based on information of a designated gloss, the second liquid being an ultraviolet-curable liquid.

10. The printing method according to claim 7, further comprising:
irradiating the image layer and the adhesive layer on the base material with ultraviolet light by an irradiator; and
controlling the irradiator to irradiate the adhesive layer with the ultraviolet light in an irradiation time shorter than or at an irradiation intensity lower than to irradiate the image layer with the ultraviolet light, each of the first liquid and the second liquid being an ultraviolet-curable liquid.
